(19) United States
(12) Patent Application Publication
(10) Pub. No.: US 2023/0113543 A1
(43) Pub. Date: Apr. 13, 2023

(54) METHODS OF MANUFACTURE OF HAIR FASTENERS AND HAIR FASTENERS MADE THEREFROM

(71) Applicant: Tung Hing Plastic Manufactory Ltd., Hong Kong (HK)

(72) Inventor: Ka Chuen SZE, Hong Kong (HK)

(73) Assignee: Tung Hing Plastic Manufactory Ltd., Hong Kong (HK)

(21) Appl. No.: 18/065,601

(22) Filed: Dec. 13, 2022

Related U.S. Application Data
(63) Continuation-in-part of application No. 16/417,686, filed on May 21, 2019.
Application No. 16/417,686 is a continuation of application No. 14/962,076, filed on Dec. 8, 2015, now abandoned.

(30) Foreign Application Priority Data
Jan. 28, 2015 (GB) 1501421.0

(51) Int. Cl. A45D 8/34

(52) U.S. Cl. CPC A45D 8/34

(57) ABSTRACT

The present invention is concerned with a method of manufacture of a hair fastener. The method includes the steps of i) providing at least one elastic band with a length of 65-205 mm and a width or diameter of 0.8-10 mm, wherein the elastic band defines ends surface at opposite ends thereof, ii) knitting a layer of fabric over and along the length of the elastic band; iii) connecting the opposite ends by a first connector thus effecting the elastic band taking the form of loop, wherein the first connector is an adhesive; iv) connecting the opposite ends by a second connecter, wherein the second connector is formed by molding over the first connector at the opposite ends, and bonding the second connector, the fabric cover and the elastic band at the opposite ends together.

### CROSS REFERENCE TO RELATED APPLICATIONS

This application is a Continuation-in-part application from U.S. patent application Ser. No. 16/417,686 filed May 21, 2019 which is a Continuation-in-part application from U.S. patent application Ser. No. 14/962,076 filed Dec. 8, 2015 which claims priority from GB Patent Application No. 1501421.0 filed Jan. 28, 2015, contents of all three earlier filed applications are incorporated herein in their entirety.

### FIELD OF THE INVENTION

The present invention is concerned with a method of manufacture of a hair fastener and in particular a method of manufacture of a closed-loop hair tie, and a hair fastener manufactured therefrom.

### BACKGROUND OF THE INVENTION

The following discussion of the background art is intended to facilitate an understanding of the present invention only. It should be appreciated that the discussion is not an acknowledgement or admission that any of the material referred to was part of the common general knowledge as at the priority date of the application.

There is a variety of hair fasteners and methods of making thereof. One type of historical hair fasteners is in the form of an elastic band integrally formed into an elastic loop. However, this type of fasteners is disadvantageous because due to the material used hair tends to get tangled with the loop and cause damage to hair. Removal of such hair fasteners after use is thus challenging. An improvement has existed to provide a layer of fabric over the elastic loop before closing the loop.

A further problem is that, due to the conventional and often low-cost nature of conventional hair fasteners, they, among other disadvantages, tend to break easily at where the loop closes. Some users typically would not give much thought about this and simply treat hair fasteners as readily disposable items. This is environmentally unfriendly. Other users would simply blame themselves for breaking the hair fasteners often.

The present invention seeks to address these problems, or at least to provide an alternative to the public.

### SUMMARY OF THE INVENTION

According to an aspect of the present invention, there is provide a method of manufacture of a hair fastener with an improved pull strength comprising the steps of:

providing at least one elastic band with a length of 65-205 mm and a width or diameter of 0.8-10 mm, wherein the elastic band defines ends surface at opposite ends thereof and is made of a material selected from the group consisting of silicone, thermoplastic elastomer (TPE) and polyester-polyurethane copolymer elastane,

knitting a layer of fabric over and along the length of the elastic band, wherein the fabric is made of a material selected from the group consisting of nylon and polypropylene,

connecting the opposite ends by a first connector thus effecting the elastic band taking the form of loop, wherein the first connector is an adhesive, and wherein the connecting of the opposite ends by the first connector does not increase the width or circumferential diameter of the elastic hand at the first connector;

connecting the opposite ends by a second connecter, wherein the second connector is formed by molding over the first connector at the opposite ends, and bonding the second connector, the fabric cover and the elastic band at the opposite ends together, wherein:

the second connector envelops the first connector,

the thickness of the second coupler is from 1-4 mm such that the overall width of the closed loop hair fastener at the connection region is increased by the second coupler by 2-8 mm, and the length of the second connector is 0.58-2.72 cm,

the second connector is made from a material of thermoplastic elastomer, wherein the thermoplastic elastomer of the second connector is free of silicone rubber, rubber or polyvinyl chloride (PVC), and due to the dimensional properties and the physical properties of the combination of the materials of the elastic band, the fabric cover and the second connector, the bonding together of the second connector, the fabric cover and the elastic band at the opposite ends is enhanced and the pull strength is increased.

Preferably, the second connector may assume a columnar formation defining a through-hole in which the first coupler resides, and wherein the through-hole may have a consistent width.

Suitably, the adhesive may be selected from members of a cyanoacrylate family.

Advantageously, the hair fastener may be free of any clamps, clips, or metallic components.

In an embodiment, the length of the second connector may be 0.58-1.72 cm.

In one embodiment, the ratio of the width and the length of the elastic band section may be 0.8 to 10:65 to 400; the ratio of the thickness of the second coupler to the length of the second coupler may be 1 to 4:5.8 to 27.2; the ratio of the thickness of the second coupler to the circumferential length of the hair fastener may be 1 to 4:65 to 400; the ratio of the length of the second coupler and the circumferential length of the hair fastener may be 5.8 to 27.2 to 40:65 to 400; and the ratio of the width of the elastic band and the length of the elastic band may be 0.8 to 10:65 to 400.

In one embodiment, the elastic band at the first and second connectors may have a pull strength of 3 to 20 Kg.

In another embodiment, the elastic band at the first and second couplers may have a pull strength of 10 to 20 Kg.

In a further embodiment, the elastic band at the first and second couplers may have a pull strength of 3 Kg.

In a specific embodiment, during the overmolding, free ends of the fabric of the jacket at the opposite ends are heat-fused and secured to the elastic band due to elevated temperate and the combination of the particular materials of the elastic band, the fabric cover and the second connector.

In an alternative embodiment, the step of knitting the layer of fabric may include knitting over and along the length of two said elastic bands arranged side by side thus forming one fabric jacket over both the elastic bands.

### BRIEF DESCRIPTION OF DRAWINGS

Some embodiments of the present invention will now be explained, with reference to the accompanied drawings, in which:

FIG. 1 is a schematic diagram showing a user wearing a conventional hair fastener;

FIG. 2 is a perspective view showing the hair fastener of FIG. 1;

FIG. 3 is a perspective view of the hair fastener of FIG. 2;

FIG. 4 is a schematic diagram showing an elongate elastic band or member with a layer of fabric being knitted thereover for forming an embodiment of a hair fastener in accordance with the present invention;

FIGS. 5, 6a, 6b and 6c are schematic diagrams showing an elastic band section made from the elongate elastic band of FIG. 4, and a subsequent step of closing of the elastic band section to form a closed-loop member of the fastener;

FIG. 7 is a schematic diagram showing encasing of a connecting region of the hair fastener from FIG. 6c;

FIGS. 8, 9 and 10 are perspective and side views of the fasteners from FIG. 7 after processing; and

FIG. 11 is a schematic diagram showing the fastener of FIG. 10 worn by a user.

### PREFERRED EMBODIMENTS OF THE INVENTION

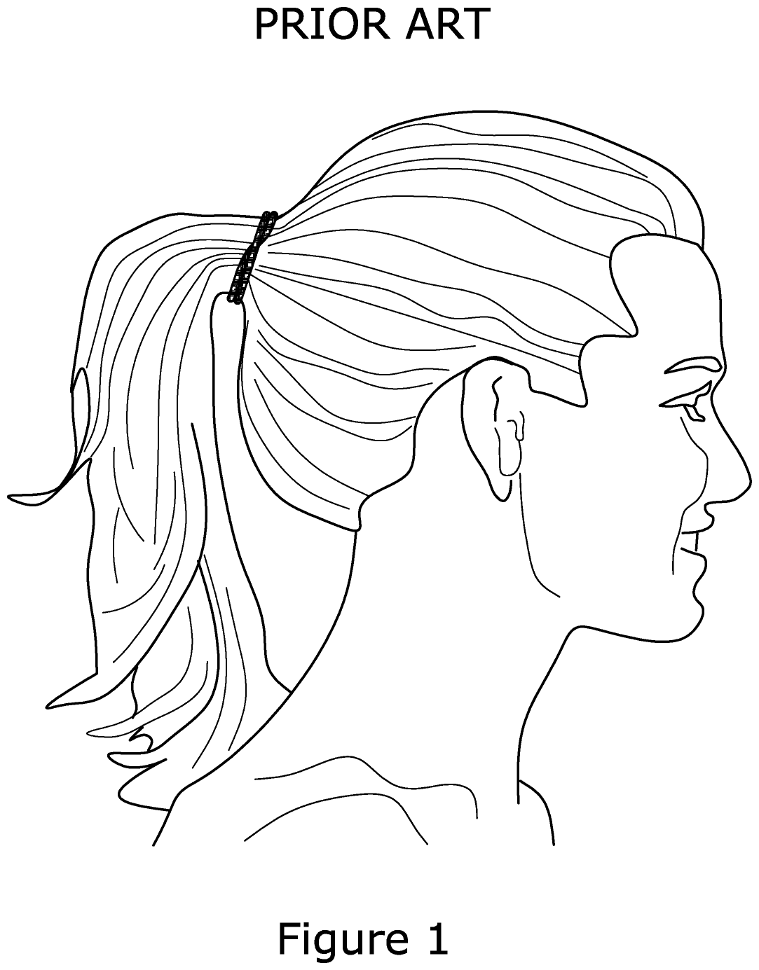

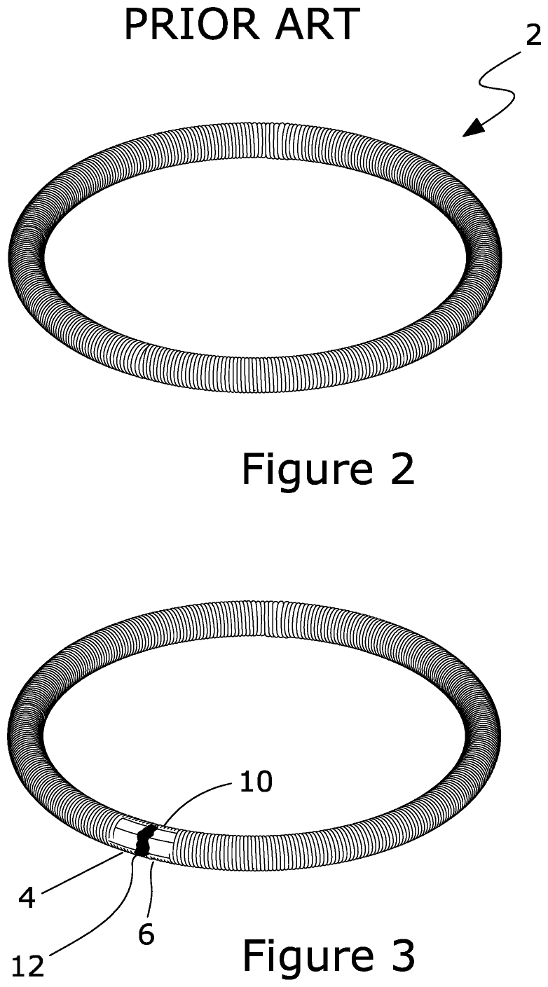

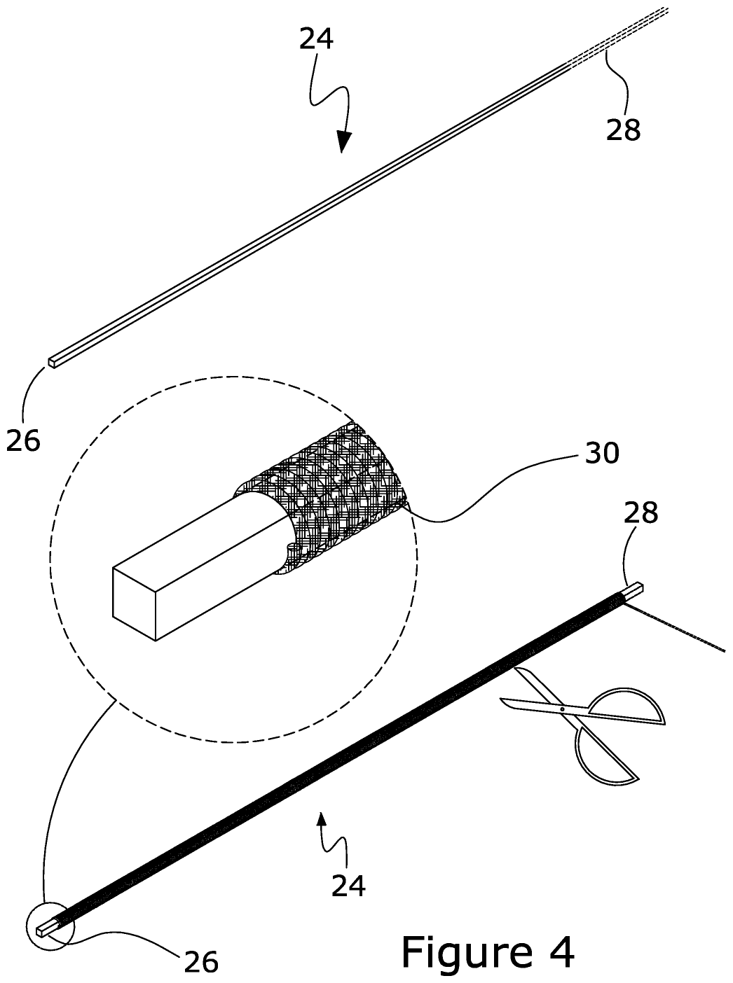

FIGS. 1 to 3 show a prior art hair fastener 2. Such fasteners are typically formed by providing an elongate elastic member with opposite ends 6, 8. A layer of fabric 10 is provided to cover the elastic member. The opposite ends are connected together by a metal crimp 12 on top of the layer of fabric. While the metal crimp 12 connects the opposite ends, on repeated stretching the metal crimp 12 actually cut open the opposite ends thus breaking the connection.

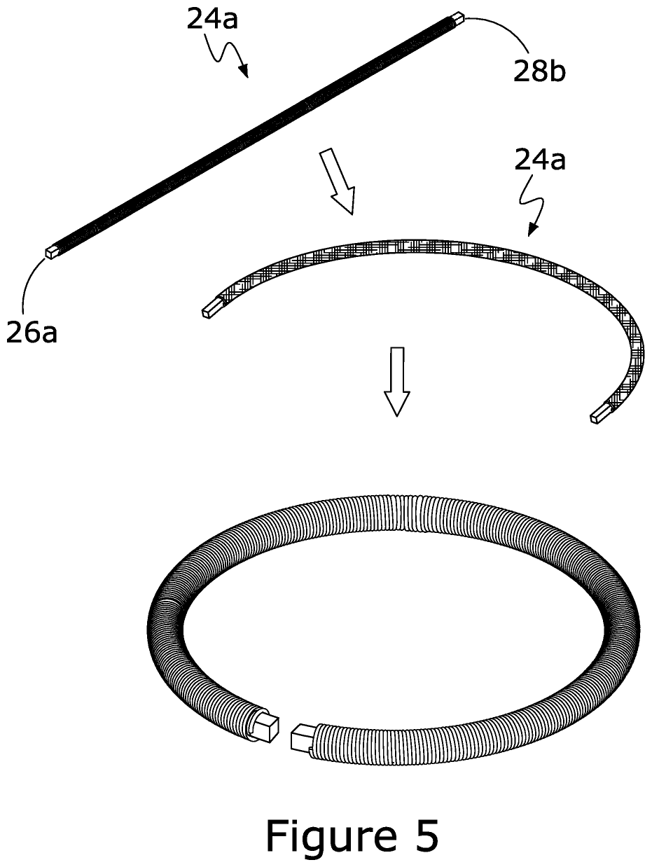

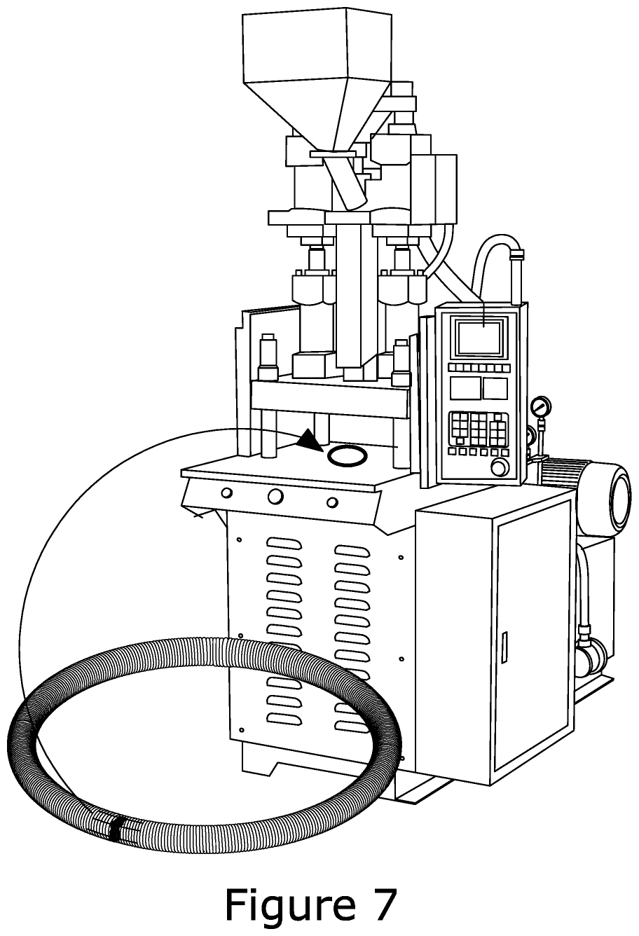

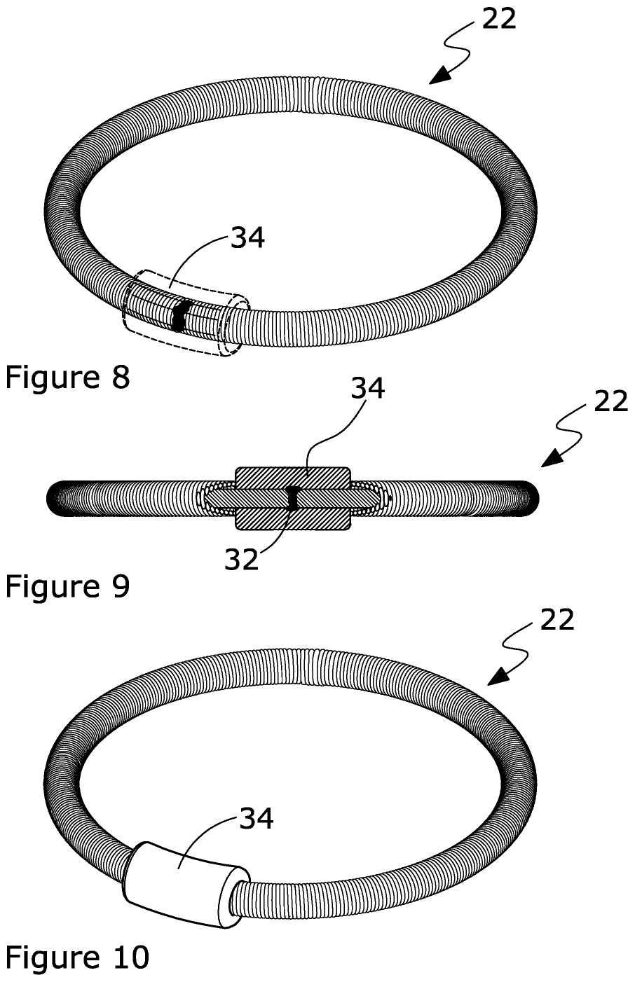

FIG. 10 illustrates an embodiment of a hair fastener 22 in the form of a closed-loop hair tie according to the present invention. FIGS. 8-9 are schematic views showing an interior structure of a connecting region of the fastener 22. The hair fastener 22 is firstly illustrated by way of its method of manufacture as shown in FIGS. 4 to 7.

FIGS. 4 to 7 illustrate an embodiment of a method of manufacture of a hair fastener 22 in the form of a closed-loop hair tie according to the present invention. FIG. 4 shows initial steps in which an elongate elastic band 24 is provided. The elastic band 24 is made of a high elasticity material selected from the group consisting of silicone, thermoplastic elastomer (TPE) and polyester-polyurethane copolymer elastane. The elastic band 24 has a rectangular, square or circular cross section. The elastic band 24 has a circumferential diameter or width 0.8-10 mm. The present invention can exist in at least two configurations in which in a first configuration the elastic band 24 has a circular cross section, and in that configuration the diameter of the elastic band is from 1.8-8.0 mm. In a different configuration, the elastic band 24 has a cross section of a square shape (or a quadrilateral). The significance of the diameter and width parameter will be explained later below.

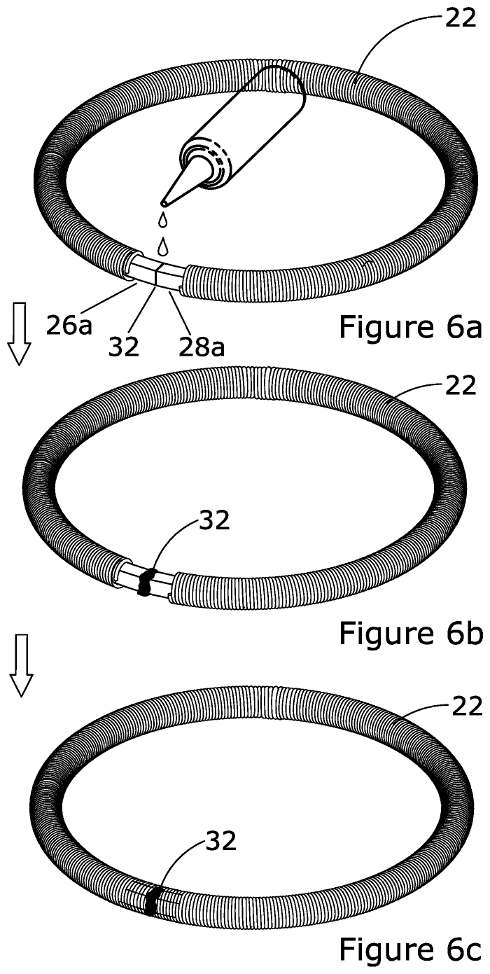

After providing the elongate elastic band 24, a step is performed by knitting a layer of fabric 30 over a majority length or essentially an entire length of the open-ended elastic band 24. In this embodiment, the fabric 30 used is made of essentially nylon although studies leading to the present invention identifies that the fabric may be made of polypropylene or a combination of nylon and polypropylene. In the context of the present invention, nylon is one preferred material because fabric formed therefrom possesses appropriate surface texture. The significance of the use of nylon and/or polypropylene will be explained further later below. In this step, the knitting is initially performed with the opposite ends still being un-connected yet. As the knitting is almost being completed such that the majority of the surface of the elastic band is covered, it is cut into elastic band sections 24a with desired lengths. The elastic band sections 24 have a length of 65-400 mm for making respective closed-loop hair ties. In other preferred embodiments, the elastic band sections 24a have a length of 65-205 mm such the closed-loop hair ties made therefrom also have a circumferential length of 65-205 mm. The significance of the length of the hair fastener will be explained further below. Regardless of the dimensional profile of the elastic band sections 24a, each elastic band section has end surfaces defined by open ends designated 26a, 28a and circumferential surface along an elongate length of the elastic band 24. Please see FIG. 5.

In an alternative embodiment, more than one elastic band is used and a fabric material is knitted over the two or more elastic band. For example, two elastic bands may be used and a fabric material is knitted over the two elastic bands arranged side by side simultaneously.

The opposite ends 26a, 28a of each elastic band section 24a are then connected together by positioning the opposite ends 26a, 28a adjacent each other and joining them by an adhesive. The adhesive itself forms a first connector or first coupler 32 connecting the opposite ends. In this embodiment, the adhesive used is generally known as or contains a glue in the cyanoacrylate family. It is to be noted that no metallic clip or clamp penetrating or crimping the opposite ends 26a, 28a is provided. This is deliberate and advantageous because, during research and studies leading to the present invention, it was identified that under repeated stretching the use of metal clamps would actually induce breakage at the opposite ends 26a, 28a. In other words, embodiments of fasteners made in accordance with the present invention is advantageous in at least a two-fold manner. First, they can reduce breakage of hair when they are removed or unfastened from hair. Second, in the absence of the metallic clip or crimp breakage at the region of the opposite ends is much reduced. It is also to be appreciated that the use of the adhesive can avoid the use of rigid or metallic components and can avoid substantially increasing the width or diameter of region by the first connector 32.

After an elastic closed-loop member is formed by joining opposite ends 26a, 28a, it is subjected to a step of overmoulding thus forming a second connector or a second coupler 34 over region of the connected opposite ends 26a, 28a at the first connector 32. The second connector 34 is formed by injection moulding of a material of thermoplastic elastomer, but free of silicone rubber, rubber or polyvinyl chloride (PVC). It is to be noted that “thermoplastic elastomer” refers a class of material which can be copolymers or (emphasis added) a physical mix of polymers which can be a plastic and a rubber. In the former scenario, the thermoplastic elastomer exists as copolymers which are compounds chemically bonded together and they are not rubber. For example, styrene block copolymers are a thermoplastic elastomer which is not and does not include any rubber. There are examples in which a thermoplastic elastomer is not and does not include any rubber ingredient. Accordingly, it is to be understood that only certain thermoplastic elastomers can be used in the context of this invention.

In this embodiment, the second connector 34 has an elongate profile and a columnar formation with a through-hole in which the first coupler 31 resides and via which the hair fastener 22 passes. The hair fastener 22 with the second coupler 34 when viewed externally resembles a bead with a void therein. The through-hole has a consistent width. Specifically, the elongate band 24a and opposite ends of the nylon fabric layer are moulded over by the second coupler 34; free ends of the nylon fabric at the opposite ends 26a, 28a are also connected by the second coupler 34. The second connector 34 thus acts as an envelope protecting, encasing and bridging this region and enhance connection of the opposite ends. During overmolding of the second connector 34 over the opposite ends 26a, 26b, the free ends of nylon fabric is also subjected to an elevated temperature such that the nylon fabric at the free ends is heat-fused to the underlying elastic band section at the opposite ends 26a, 28a, effectively welded to the elastic band section. The welding effect enhances gripping of the fabric to the elastic band section at the opposite ends 26a, 28a. As such, the second connector 34 not only provides a secondary connection to the opposite ends of the elongate band section 24a but also enhances gripping of the nylon fabric layer to the opposite ends of the elongate band section 24a at the first connector. The second connector 34 once secured is irremovable from the first connector 32. The second connector 24 is not slidable and not shrinkable before or after having connected to the first coupler 32. Due to the molding over of the first coupler 32, the second coupler 34 essentially takes the form of a shell forming on the first coupler 31, and fixedly enveloping and around and encasing the first coupler 32 and opposite ends of the nylon fabric jacket. Studies leading to the present invention indicates that the thickness of the shell ranges from 1-4 mm for achieving the intended characteristics of the hair fastener 22. When the opposite ends are jacketed with the shell, the width of the hair fastener at the second coupler 34 is increased from 0.8-10 mm by 1-4 mm, thus the total width of the hair fastener thereat would be up to 18 mm. The length of the second connector 34 ranges from 5.8-27.2 mm, or more preferably 5.8-17.2 mm. With these configurations, the following ratio can be summarized.

TABLE 1
Comparison of dimensions of hair fastener

| Comparison | Ratio |
|---|---|
| Width of elastic band to length of hair faster | 0.8-10:65-400 |
| Thickness of columnar wall of second | 1-4:5.8-27.2 |
| coupler to length of second coupler | |
| Thickness of shell of second coupler to | 1-4:65-400 |
| length of hair fastener | |
| Length of second coupler to length of hair | 5.8-27.2:65-400 |
| fastener | |
| Width of elastic band to thickness of shell | 0.8-10:1-4 |
| of second coupler | |
| Thickness of shell of second coupler to | 1-4:5.8-27.2 |
| length of second coupler | |

The above has discussed the material characteristics as well and the dimensional characteristics of the hair fastener 2. It is to be noted that both these characteristics together are important in achieving the desired functional characteristics of the hair fastener 22. With regard to the material characteristics of the fabric material, studies leading to the present invention indicates that while different materials could be used, only relatively few materials when used would lead to the desired effect. In the context of this invention, the use of nylon or polypropylene for the fabric layer is selected because they possess unique and somewhat conflicting surface features. On one hand, it has sufficiently smooth surface texture and yet during molding by the second connector it can grip onto and bond well to the underling elastic band such that the second connector, the fabric layer and the underlying elastic band can all be connected together secured. With regard to the material of the second connector, studies leading to the present invention indicates that while different materials could be used, only relatively few materials used would lead to the desired effect. Studies leading to the present invention indicates that not any thermoplastic elastomer material would work equally well. Specifically, thermoplastic elastomer materials excluding silicone rubber, rubber or polyvinyl (PVC) should be used. If inappropriate materials were used for the second connector, the bonding would unsatisfactory, and the first and second connectors would undesirably become weaker and thus the hair fastener would not have the desired strength.

With regard the dimensional characteristics, the desired strength of the hair fastener will arise only if the dimensional characteristics are present. For example, if the elastic band were thicker or longer than the stipulated ranges, the desired strength characteristics would not arise.

These dimensional characteristics provides that the second coupler 34 can provide sufficient connection strength to the opposite ends and protection to the first coupler but do not interfere with tidying or gripping of hair by the hair fastener. Further, it is to be noted that the second coupler 34 is deformable with the elastic band section 24a. Thus, when the hair fastener 22 is bent and flex during hair tying, the second coupler 34 flexes along to confirm to the surface of the hair to be tided.

The elastic band 24 is made of silicone, thermoplastic elastomer or polyester-polyurethane copolymer elastane. The fabric of the jacket is selected from the group consisting of fibers of nylon and polypropylene, and the thermoplastic elastomer material of the second coupler is thermoplastic elastomers but excluding silicone rubber, rubber or polyvinyl chloride (PVC). It is to be noted that the use of these material candidates is not arbitrary. During research and development leading the present invention, it was identified that under elevated temperature, specific combinations of the particular selected materials for the elastic band, fabric and second coupler can allow substantially better heat-fusing of the fabric to the underlying elastic band section.

The second coupler 34 is made with a material with higher frictional surface. Due to the higher frictional surface of the second coupler material, it also enhances the fasteners to grip on the hair being tight and thus to increase its gripping capability. In other embodiments, the second coupler may be configured to adopt the configuration of a decorative item.

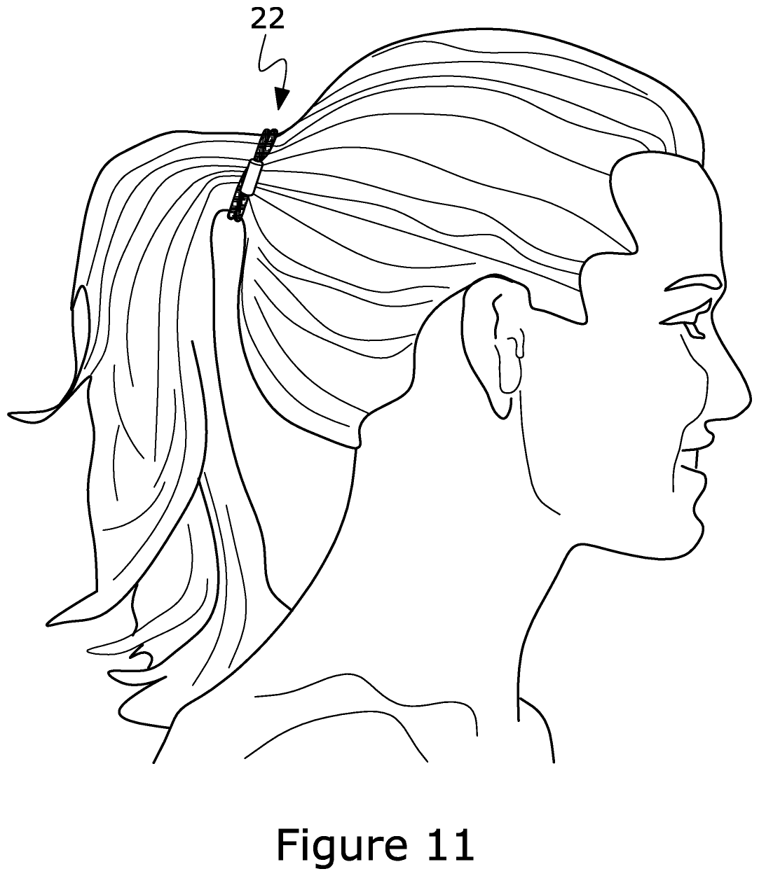

FIG. 11 shows the hair fastener 22 worn on a user.

The hair fastener 22 is also characterised in that while along the length of the fastener both of the elastic band portion and the surrounding fabric portion are elastically and reciprocatingly stretchable, the connection region at which the first coupler and the second coupler resides is also elastically deformable. This is due to the material, structural and configurational characteristics of the elastic band, the surrounding fabric, the first coupler and the second coupler.

Hair fasteners made in accordance with the present invention are advantageous in a number of ways. First, the use of dual connection, i.e. i) adhesion by adhesive of the opposite ends and ii) connection by coupler at the opposite ends over the nylon fabric significantly improve repeated tension of the hair fastener. Studies show that such hair fasteners have a pull strength at the region of the coupler of 3 Kg, 4 Kg, 4 Kg to 15 Kg, or >3 Kg to 20 Kg. Second, the use of the second coupler made of TPE is advantageous because this particular material can provide contact comfort which is not possible when using for example natural rubber. Further, optionally, without the use of metallic crimp or clip in connecting the opposite ends of the elastic band, the drawback of the opposite ends actually torn apart by the crimp or clip is prevented. The possibility of an exposed metallic clip tearing off user's hair in use is also prevented.

It should be understood that certain features of the invention, which are, for clarity, described in the content of separate embodiments, may be provided in combination in a single embodiment. Conversely, various features of the invention which are, for brevity, described in the content of a single embodiment, may be provided separately or in any appropriate sub-combinations. It is to be noted that certain features of the embodiments are illustrated by way of non-limiting examples. Also, a skilled person in the art will be aware of the prior art which is not explained in the above for brevity purpose.

1. A method of manufacture of a hair fastener with an improved pull strength comprising the steps of:
providing at least one elastic band with a length of 65-205 mm and a width or diameter of 0.8-10 mm, wherein the elastic band defines ends surface at opposite ends thereof and is made of a material selected from the group consisting of silicone, thermoplastic elastomer (TPE) and polyester-polyurethane copolymer elastane,
knitting a layer of fabric over and along the length of the elastic band, wherein the fabric is made of a material selected from the group consisting of nylon and polypropylene,
connecting the opposite ends by a first connector thus effecting the elastic band taking the form of loop, wherein the first connector is an adhesive, and wherein the connecting of the opposite ends by the first connector does not increase the width or circumferential diameter of the elastic hand at the first connector;
connecting the opposite ends by a second connecter, wherein the second connector is formed by molding over the first connector at the opposite ends, and bonding the second connector, the fabric cover and the elastic band at the opposite ends together, wherein:
the second connector envelops the first connector,
the thickness of the second coupler is from 1-4 mm such that the overall width of the closed loop hair fastener at the connection region is increased by the second coupler by 2-8 mm, and the length of the second connector is 0.58-2.72 cm,
the second connector is made from a material of thermoplastic elastomer, wherein the thermoplastic elastomer of the second connector is free of silicone rubber, rubber or polyvinyl chloride (PVC), and due to the dimensional properties and the physical properties of the combination of the materials of the elastic band, the fabric cover and the second connector, the bonding together of the second connector, the fabric cover and the elastic band at the opposite ends is enhanced and the pull strength is increased.

2. A method as claimed in claim 1, wherein the second connector assumes a columnar formation defining a through-hole in which the first coupler resides, and wherein the through-hole has a consistent width.

3. A method as claimed in claim 1, wherein the adhesive is selected from members of a cyanoacrylate family.

4. A method as claimed in claim 1, wherein the hair fastener is free of any clamps, clips, or metallic components.

5. A method as claimed in claim 1, wherein the length of the second connector is 0.58-1.72 cm.

6. A method as claimed in claim 1, wherein:
the ratio of the width and the length of the elastic band section is 0.8 to 10:65 to 400;
the ratio of the thickness of the second coupler to the length of the second coupler 1 to 4:5.8 to 27.2;
the ratio of the thickness of the second coupler to the circumferential length of the hair fastener is 1 to 4:65 to 400;
the ratio of the length of the second coupler and the circumferential length of the hair fastener is 5.8 to 27.2 to 40:65 to 400; and
the ratio of the width of the elastic band and the length of the elastic band is 0.8 to 10:65 to 400.

7. A method as claimed in claim 1, wherein the elastic band at the first and second connectors has a pull strength of 3 to 20 Kg.

8. A method as claimed in claim 7, wherein the elastic band at the first and second couplers has a pull strength of 10 to 20 Kg.

9. A method as claimed in claim 7, wherein the elastic band at the first and second couplers has a pull strength of 3 Kg.

10. A method as claimed in claim 1, wherein during overmolding free ends of the fabric of the jacket at the opposite ends are heat-fused and secured to the elastic band.

11. A method as claimed in claim 1, wherein the step of knitting the layer of fabric includes knitting over and along the length of two said elastic bands arranged side by side thus forming one fabric jacket over both the elastic bands.
